(19) United States
(12) Patent Application Publication
(10) Pub. No.: US 2022/0258151 A1
(43) Pub. Date: Aug. 18, 2022

(54) EX-SITU CONDITIONING OF A CATALYST COMPOSITION IN PREPARATION FOR A SULFIDING TREATMENT

(71) Applicant: EVONIK OPERATIONS GMBH, Essen (DE)

(72) Inventors: Sean Michael BANKER, Houston, TX (US); James Dallas SEAMANS, The Woodlands, TX (US)

(73) Assignee: EVONIK OPERATIONS GMBH, Essen (DE)

(21) Appl. No.: 17/629,380

(22) PCT Filed: Jul. 24, 2020
(86) PCT No.: PCT/US2020/043383

§ 371 Date: Jan. 22, 2022

Related U.S. Application Data
(60) Provisional application No. 62/878,623, filed on Jul. 25, 2019.

(51) Int. Cl. B01J 37/08; B01J 37/20; B01J 23/883; B01J 23/882; B01J 35/04

(52) U.S. Cl. CPC B01J 37/084; B01J 37/20; B01J 35/04; B01J 23/882; B01J 23/883

(57) ABSTRACT

A system and method of ex-situ conditioning an organic treated catalyst composition is disclosed. An example of a method comprises ex-situ conditioning an organically treated catalyst composition by heating the organically treated catalyst composition in a treatment gas flow to form an ex-situ conditioned catalyst composition The ex-situ conditioned catalyst may be further subjected to an ex-situ sulfiding process or may be provided directly to a refinery, where it may undergo in-situ sulfiding.

### FIELD

The present techniques relate generally to ex-situ treated catalyst compositions for hydrotreating in refineries. Specifically, the techniques relate to ex-situ treating catalyst compositions that have been treated with organic compounds during initial production, prior to providing these compositions to a refinery.

### BACKGROUND

Hydroprocessing catalysts may include catalyst compositions for hydrotreating, hydrocracking, and so forth. A hydrotreating catalyst may be a catalyst composition employed to catalyze the hydrogenation of hydrocarbon feedstocks, and more particularly, to hydrogenate particular components of the feedstock, such as sulfur-, nitrogen- and metals-containing organo-compounds and unsaturates. A hydrocracking catalyst may be a catalyst composition employed to crack large petroleum derived molecules to attain smaller molecules with the concomitant addition of hydrogen to the molecules.

One application of hydrotreating catalyst is the hydrotreating or hydrogenation of pyrolysis gasoline or pygas. Pygas may be a naphtha-range product with a high aromatics content. Pygas (e.g., C5+ cut) may be a liquid by-product derived from steam cracking of various hydrocarbon feedstocks in olefin plants. Indeed, pygas may be a by-product of high temperature naphtha cracking during ethylene and propylene production. In general, pygas may be a high-octane number mixture which contains aromatics, olefins and paraffins ranging from C5s to C12s.

Catalyst compositions for hydroprocessing, such as for hydrotreating, hydrocracking, or pygas treating, may have metal oxide catalysts including cobalt-molybdenum, nickel-tungsten, and nickel-molybdenum. The catalysts may also have boron in their formulation. The catalysts may be supported typically on alumina, titania, silica, titania-alumina, silica-titania, and silica-alumina, including zeolite carriers, and so on. Also, transition element catalysts may be employed as hydroprocessing catalysts. In general, the hydroprocessing catalysts may have at least one element selected from V, Cr, B, Mn, Re, Co, Ni, Cu, Zn, Mo, W, Rh, Pd, Pt, Ag, Au, Cd, Sn, Sb, Bi and Te.

To gain further efficiencies in these catalysts, research has focused on additives and treatments to the catalyst compositions. For example, catalysts treated with organic compounds prior to use may show increased efficiencies. These organic compounds may include polar heterocyclic compounds, organic acids, and polyacidic compounds, among others.

The economics of hydroprocessing, such as hydrotreating (hydrogenation), hydrocracking, or pygas treatment, among others, and the associated catalyst compositions, drives improvements in activity and catalyst life. In these industries, very large amounts of feedstocks are processed annually, and small incremental improvements in the catalyst and processing can give substantial economic benefit.

### SUMMARY

Examples described herein provide a method of ex-situ treating an organically treated catalyst composition. The method includes heating the organically treated catalyst composition in a treatment gas flow to form an ex-situ treated catalyst composition. The ex-situ treated catalyst composition is provided to a refinery.

The organically treated catalyst composition may include chromium, molybdenum, or tungsten, or any combinations thereof. In some examples, the organically treated catalyst composition includes nickel or cobalt. The organically treated catalyst composition may be treated with organic compounds including an acetoacetic acid compound, a polar heterocyclic compound, or a carbonate in a catalyst production process.

Heating the organically treated catalyst composition may include flowing nitrogen over the organically treated catalyst composition for less than about two hours at a temperature of less than about 230° C. or less than about 250° C. Heating the organically treated catalyst composition may include flowing a mixture of nitrogen and hydrogen over the organically treated catalyst composition for less than about two hours at a temperature of less than about 230° C. or less than about 250° C. Heating the organically treated catalyst composition may include flowing an inert gas or a mixture of inert gas and a reducing gas over the organically treated catalyst composition for at least one hour at a temperature of greater than about 125° C. Heating the organically treated catalyst composition may include flowing an inert gas or a mixture of inert gas and a reducing gas over the organically treated catalyst composition at a temperature of between about 125° C. and about 160° C. for about 1 to about 2 hours.

An ex-situ sulfurization of the ex-situ treated catalyst composition may be performed to form an ex-situ sulfurized catalyst composition. Performing the ex-situ sulfurization may include contacting the ex-situ treated catalyst composition with a sulfur source to form a mixture, and heating the mixture to form the ex-situ sulfurized catalyst composition. Performing the ex-situ sulfurization may include contacting the ex-situ treated catalyst composition with sulfur and organic compounds to form a mixture, and heating the mixture to form the ex-situ sulfurized catalyst composition. The organic compounds may include an olefin, or a triglyceride, or both. Forming the ex-situ sulfurized catalyst composition may include contacting the organically treated catalyst composition with sulfur to give an initial mixture including a sulfur-incorporated catalyst, contacting the initial mixture with an organic compound to form a mixture, and heating the mixture to form the ex-situ sulfurized catalyst composition.

An ex-situ sulfiding of the ex-situ sulfurized catalyst composition may be performed. The ex-situ sulfiding of the ex-situ sulfurized catalyst composition may include heating the ex-situ sulfurized catalyst composition under hydrogen.

An ex-situ sulfiding of the ex-situ treated catalyst composition may be performed to form an ex-situ sulfided catalyst composition. Performing the ex-situ sulfiding may include contacting the ex-situ treated catalyst composition with a sulfur source to form a mixture, and heating the mixture under a flow of hydrogen to form the ex-situ sulfided catalyst composition. Performing the ex-situ sulfiding may include contacting the ex-situ treated catalyst composition with sulfur and organic compounds to form a mixture, and heating the mixture under a flow of hydrogen to form the ex-situ sulfided catalyst composition. The organic compounds may include an olefin, or a triglyceride, or both.

Examples described herein provide a catalyst composition, including an ex-situ treated catalyst composition formed by heating an organically treated catalyst composition in a gas flow.

The organically treated catalyst composition may include chromium, molybdenum, or tungsten, or any combinations thereof. The organically treated catalyst composition may include nickel or cobalt. The organically treated catalyst composition may be treated with an organic compound including an acetoacetic acid compound, a polar heterocyclic compound, or a carbonate in a catalyst production process.

The catalyst composition may include an ex-situ sulfurized catalyst composition formed by contacting the ex-situ treated catalyst composition with sulfur to form a mixture, and heating the mixture. The catalyst composition may include an ex-situ sulfurized catalyst composition formed by contacting the ex-situ treated catalyst composition with sulfur and an organic compound form a mixture, and heating the mixture. The organic compound may include an olefin, or a triglyceride, or both.

Heating the catalyst composition may include heating the mixture to at least 150° C. Heating the catalyst composition may include maintaining a temperature of at least 150° C. for a time in a range of about 0.1 hours to about 10 hours.

The catalyst composition may include an ex-situ sulfurized catalyst composition an ex-situ sulfurized catalyst composition formed by contacting the organically treated catalyst composition with sulfur to give an initial mixture, contacting the initial mixture with an organic compound to form a mixture, and heating the mixture.

Also disclosed herein is a method of conditioning an organically treated catalyst composition in preparation for a sulfiding treatment, the method comprising: heating the organically treated catalyst composition in a treatment gas to form an ex-situ conditioned catalyst composition; wherein the organically treated catalyst composition comprises: at least one metal supported on a porous support, and at least one organic reagent absorbed in pores of the porous support, and wherein the heating decomposes at least a portion of the organic reagent leaving carbonaceous species in pores of the porous support. According to some embodiments the organically treated catalyst composition has a carbon percent that is greater than 8% prior to heating. According to some embodiments the organically treated catalyst composition comprises chromium, molybdenum, or tungsten, or any combinations thereof. According to some embodiments the organically treated catalyst composition comprises nickel or cobalt. According to some embodiments the organic reagent comprises one or more of an organic acid, an acetoacetic acid compound, a polar heterocyclic compound, a polyacidic compound, a nitrogen-containing organic compound, or a carbonate. According to some embodiments the treatment gas comprises less than 10% oxygen. According to some embodiments the treatment gas is nitrogen. According to some embodiments the treatment gas is a mixture of nitrogen and hydrogen. According to some embodiments the heating comprises flowing the treatment gas over the organically treated catalyst composition for up to 24 hours at a temperature of 230° C. or less. According to some embodiments the heating comprises flowing the treatment gas over the organically treated catalyst composition for one hour or less at a temperature of 125° C. or greater. According to some embodiments the heating comprises flowing the treatment gas over the organically treated catalyst composition at a temperature of 125° C. to 160° C. for 1 to 2 hours. According to some embodiments the method further comprises performing an ex-situ sulfurization of the ex-situ conditioned catalyst composition to form an ex-situ sulfurized catalyst composition. According to some embodiments performing the ex-situ sulfurization comprises: contacting the ex-situ conditioned catalyst composition with a sulfur source to form a mixture, and heating the mixture to form the ex-situ sulfurized catalyst composition. According to some embodiments performing the ex-situ sulfurization comprises: contacting the ex-situ conditioned catalyst composition with sulfur and one or more organic compounds to form a mixture; and heating the mixture to form the ex-situ sulfurized catalyst composition. According to some embodiments the one or more organic compounds comprise one or more of an olefin and a triglyceride. According to some embodiments the method further comprises performing an ex-situ sulfiding of the ex-situ sulfurized catalyst composition. According to some embodiments the ex-situ sulfiding of the ex-situ sulfurized catalyst composition comprises heating the ex-situ sulfurized catalyst composition under a hydrogen-containing atmosphere. According to some embodiments the method further comprises performing an ex-situ sulfiding of the ex-situ conditioned catalyst composition to form an ex-situ sulfided catalyst composition. According to some embodiments performing the ex-situ sulfiding comprises: contacting the ex-situ conditioned catalyst composition with a sulfur source to form a mixture; and heating the mixture under a flow of hydrogen to form the ex-situ sulfided catalyst composition.

Also disclosed here are catalyst compositions formed using any of the processes described above. For example, disclosed herein is a catalyst composition, formed by a process comprising: heating an organically treated catalyst composition in a treatment gas to form an ex-situ conditioned catalyst composition; wherein the organically treated catalyst composition comprises: at least one metal supported on a porous support, and at least one organic reagent absorbed in pores of the porous support, and wherein the heating decomposes at least a portion of the organic reagent leaving carbonaceous species in pores of the porous support.

### BRIEF DESCRIPTION OF THE DRAWINGS

The advantages of the present techniques are better understood by referring to the following detailed description and the attached drawings, in which:

FIG. 1 is a schematic diagram of an ex-situ treatment process for an organically treated catalyst composition, prior to providing the ex-situ treated catalyst composition to a refinery, in accordance with examples;

FIG. 2 is a process flow diagram of a method for the ex-situ treatment of an organically treated catalyst composition, in accordance with examples;

FIG. 3 is a process flow diagram of a method for the ex-situ sulfurization of the ex-situ treated catalyst composition, in accordance with examples;

FIG. 4 is a process flow diagram of a method for the ex-situ sulfiding of the ex-situ sulfurized catalyst composition, in accordance with examples;

FIG. 5 is a process flow diagram of a method for hydrotreating a hydrocarbon feed, in accordance with examples;

FIG. 6 is a simplified block diagram of a system for ex-situ treating of an organically treated catalyst composition with a heated treatment gas, in accordance with examples;

FIG. 7 is a simplified block diagram of a system for the ex-situ sulfurization of an ex-situ treated catalyst composition, in accordance with examples;

FIG. 8 is a simplified block diagram of a system for ex-situ sulfiding of an ex-situ sulfurized catalyst composition, in accordance with examples;

FIG. 9 is a simplified block diagram of a system for the direct ex-situ sulfiding of an ex-situ treated catalyst composition, in accordance with examples; and

FIG. 10 is a simplified block diagram of a system for hydroprocessing of a hydrocarbon feed, in accordance with examples.

### DETAILED DESCRIPTION

In the following detailed description section, specific examples of the present techniques are described. However, to the extent that the following description is specific to a particular example or a particular use of the present techniques, this is intended to be for exemplary purposes only and simply provides a description of the examples. Accordingly, the techniques are not limited to the specific examples described below, but rather, include all alternatives, modifications, and equivalents falling within the true spirit and scope of the appended claims.

As described herein, many recent generation hydroprocessing catalyst compositions contain organic post treatments, for example, as a last step in the catalyst production process. The organic post treatment enhances the activity and consumes a part of the open pore volume of the catalyst composition when it is provided to the refiner. As used herein, this provides an organically treated catalyst composition. In addition to polar heterocyclic compounds, acetoacetic acid compounds, and carbonates, other organic compounds may be used in the pretreatment of catalyst compositions. These may include, for example, propylene carbonate, N-methyl pyrrolidone, combinations of these compounds, or other organic compounds.

However, the organically treated catalyst composition may be incompatible with ex-situ pre-sulfiding techniques. For example, the ex-situ sulfiding of an organically treated catalyst composition may result a less active catalyst being delivered to a refinery.

Further, during current refinery activation, the post-treated catalysts can evolve compounds formed from the post-treatment compounds during startup. The release of these compounds can cause unexpected upsets in the refinery systems, such as excess CO₂ being adsorbed in the amine scrubber used to remove H₂S from the exit stream of a hydroprocessing reactor, resulting in saturation of the amine solvent or mercaptans formation downstream of the reactor.

Examples of the present techniques disclosed herein mitigate these issues and allow for the ex-situ sulfurization and ex-situ sulfiding techniques to be implemented on organically treated catalyst compositions. Specifically, the organically treated catalyst compositions are conditioned in an ex-situ process prior to use or further treatment. The ex-situ conditioned catalyst compositions may be provided to a refinery or used in further processing, such as in ex-situ sulfurization or ex-situ sulfiding processes, to maintain activity prior to being provided to the refinery, while substantially decreasing startup time in the refinery. In some examples, the ex-situ conditioned catalyst compositions may be ex-situ sulfurized or ex-situ sulfided prior to being provided to the refinery. This also decreases or eliminates a need for using sulfur-based chemicals at a refinery.

The ex-situ sulfurization or ex-situ sulfiding adds a sulfiding agent to the catalyst with the purpose of converting metal oxides to metal sulfides, for example, providing a more active catalyst form for delivery to the refinery. In some of these examples, an ex-situ sulfurized or ex-situ sulfided catalyst composition may be treated with an organic compound during the ex-situ sulfurization or ex-situ sulfiding operations to increase the activity over solely adding the elemental sulfur.

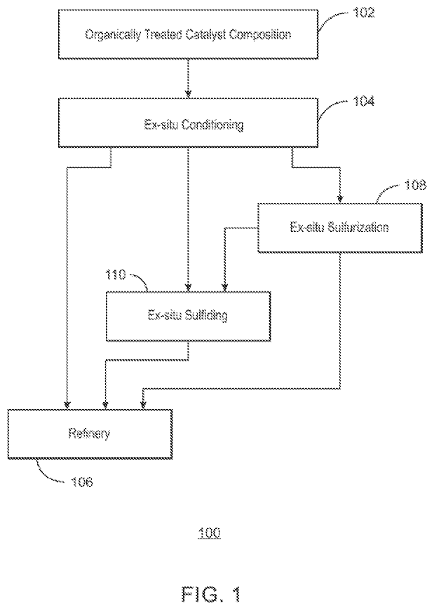

FIG. 1 is a schematic diagram of an ex-situ conditioning process 100 for an organically treated catalyst composition, prior to providing the ex-situ treated catalyst composition to a refinery, in accordance with examples. The ex-situ conditioning process 100 is used to condition an organically treated catalyst composition 102 in an ex-situ decomposition treatment 104. The ex-situ conditioned catalyst composition may be provided to a refinery 106 for use in a hydrotreating reactor, or further processed prior to being provided to the refinery 106.

The organically treated catalyst composition 102 may include a number of different hydroprocessing catalyst compositions that are treated with organic reagents as a final step in the preparation. In general, the hydroprocessing catalyst compositions may have at least one element selected from vanadium (V), chromium (Cr), boron (B), manganese (Mn), rhenium (Re), cobalt (Co), nickel (Ni), copper (Cu), zinc (Zn), molybdenum (Mo), tungsten (W), rhodium (Rh), palladium (Pd), platinum (Pt), silver (Ag), Gold (Au), cadmium (Cd), tin (Sn), antimony (Sb), bismuth (Bi), and tellurium (Te). In some examples, the hydroprocessing catalyst compositions have at least one element selected from Cr, Mo, W, Co, or Ni, or any combinations thereof. The metals are typically supported on a porous support as described above.

The elements may be in the form of metal salts, such as metal acetates, formates, hydroxides, citrates, carbonates, nitrates, sulfates, oxides, or any combinations thereof, for example, of the metals Co or Ni. In some examples, the hydroprocessing catalyst composition includes cobalt nitrate, nickel nitrate, or both. The Co or Ni, or combinations thereof, may be present in the catalyst composition in a combined amount in the range of about 0.5 weight % to 20 weight %, about 1 weight % to about 15 weight %, or about 2 weight % to 12 weight % of the element on the dry support material.

Other metal salts that may be present includes ammonium salts, such as ammonium salts of Cr, Mo, or W. In some examples, the hydroprocessing catalyst composition includes ammonium heptamolybdate, ammonium dimolybdate, or ammonium paratungstate, or any combinations thereof. The Cr, Mo, or W, or combinations thereof, may be present in the hydroprocessing catalyst composition in a combined amount in the range of about 5 weight % to about 50 weight %, from about 8 weight % to about 40 weight %, or about 12 weight % to about 30 weight %, of the element on the dry support material.

In embodiments described herein, the hydroprocessing catalyst composition catalysts are treated (i.e., impregnated) with organic compounds as a final step of the production process in order to increase efficiencies. These organic reagents may include polar heterocyclic compounds, organic acids, and polyacidic compounds, amide compounds, amine compounds, nitrile compounds, pyrrolidone compounds, urea compounds, oxalate compounds, aminocarboxylic acids, polyamines, amino alcohols, oximes, and polyethyleneimines, among others. In various examples, the organic compounds include carbonates such as propylene carbonate, acetoacetic acid compounds, N-methylpyrrolidone, or combinations thereof. In one example, acetoacetic acid is incorporated into the hydroprocessing catalyst composition to fill at least about 75% of the pore volume of the hydroprocessing catalyst composition. In other examples, polar heterocyclic compounds of the formula CₐH_{b}N_{c}O_{d}, wherein: x is an integer of at least 3; c is 0, 1, 2, or 3; d is 0, 1, 2, or 3; and b is the number of hydrogens used to complete the bonds to carbon in the structure. In various examples, the catalysts include cobalt-molybdenum (CoMo) catalyst and nickel-molybdenum (NiMo) catalysts. These catalysts are designed to remove sulfur, and nitrogen, from hydrocarbon streams as the hydrocarbon streams and a hydrogen stream are fed to a reactor.

It should be noted that the catalysts, during the last step of processing, may be impregnated by contacting it with the organic compound or with an aqueous solution of an organic compound. When the catalyst is contacted with the organic compound itself (i.e., not an aqueous solution), that typically results in a catalyst that has a percent carbon (C %) that is greater than 8%. The ex situ decomposition conditioning processes described herein are particularly useful for the conditioning of such catalysts, i.e., of impregnated catalysts having a percent carbon greater than 8%. The conditioning is typically performed on a catalysts having sulfur content of less than 50% of the stoichiometric amount required to sulfide the catalytically active metals. Typically, the sulfur content is less than about 1 wt. % of the catalyst. The ex situ decomposition conditioning processes described herein are particularly useful for catalysts that have a loss on ignition (LOI, determined as described below) of greater than 26%, and more typically, greater than 30%.

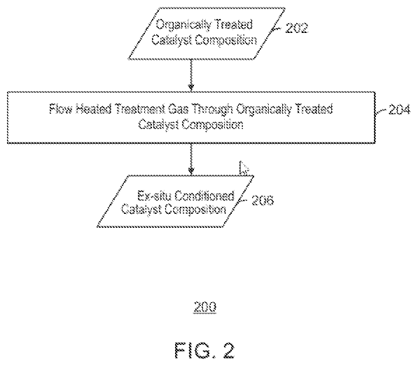

The ex-situ decomposition conditioning 104 uses a gas mixture in a specific temperature range to convert (i.e., decompose) a portion of the organic reagents on the organically treated catalyst composition 102 to high carbon content compounds (i.e., carbonaceous species) in the pores of the catalyst composition. This is described further with respect to FIG. 2.

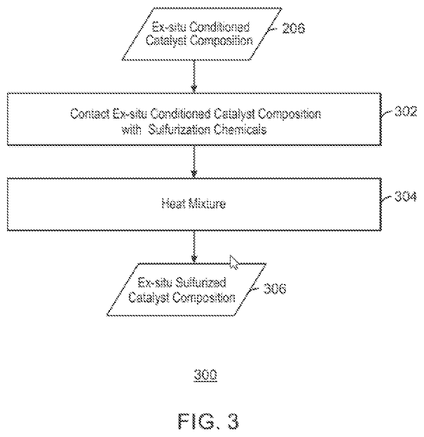

The ex-situ treated catalyst composition may be further processed in an ex-situ sulfurization 108. The ex-situ sulfurization 108 may be performed as described with respect to FIG. 3.

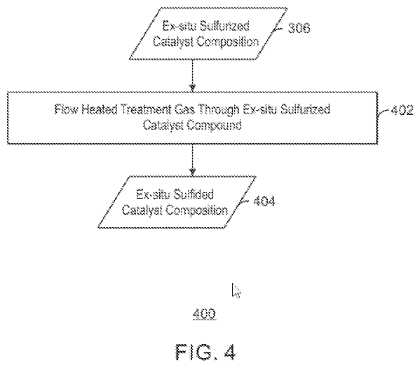

The ex-situ sulfurized catalyst composition formed in the ex-situ sulfurization 108 may be treated in an ex-situ sulfiding process 110. The ex-situ sulfiding process 110 may be performed as described with respect to FIG. 4. However, the ex-situ sulfiding process 110 does not need to be performed using the ex-situ sulfurized catalyst composition, but may be performed directly from the ex-situ treated catalyst composition formed in the ex-situ treatment 104. This may be done by combining the procedures of FIGS. 3 and 4, as described further with respect to FIG. 4.

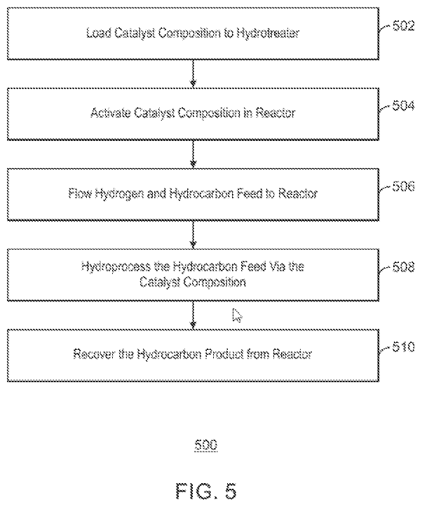

Once the ex-situ treatments are completed, the treated catalyst composition may be provided to the refinery 106, for a hydrotreating process. The hydrotreating process may be performed as described with respect to FIG. 5.

FIG. 2 is a process flow diagram of a method 200 for the ex-situ conditioning of an organically treated catalyst composition 202, in accordance with examples. The method begins at block 204 when a treatment gas is flowed through the organically treated catalyst composition 202. In some examples, the organically treated catalyst composition 202 is loaded into a batch reactor for treatment. In other examples, the organically treated catalyst composition 202 is treated in a continuous reactor, such as a calciner. For example, this may be performed at a catalyst production facility.

The treatment gas can be any inert gas or reducing gas mixture with less than about 10% oxygen, less than about 5% oxygen, less than about 1% oxygen, or less. In one example, the treatment gas is nitrogen (i.e., essentially pure nitrogen). In other examples, the treatment gas is a blend of nitrogen and hydrogen, for example, about 1% hydrogen, about 5% hydrogen, about 10% hydrogen, or less than about 25% hydrogen. The treatment gas that is flowed through the reactor is heated to a temperature of between about 100° C. and about 250° C., between about 125° C. and about 160° C., or between about 150° C. and about 155° C.

The treatment time may be about 10 minutes, 30 minutes, about 1 hour, or less than about 2 or 3 hours. The treatment time may be dependent upon the temperature treatment. For example, a higher treatment temperature, such as about 250° C. may correspond to a shorter treatment time, such as about 10 minutes. Similarly, a lower treatment temperature, such as about 125° C., may correspond to a longer treatment time, such as about 2 or 3 hours. Other processes, such as batch process may use longer treatment times, such as up to about 16 hours or up to about 24 hours.

After the conditioning is completed, the ex-situ conditioned catalyst composition 206 may be removed from the reactor and packaged for shipping to a refinery. In some examples, the ex-situ treated catalyst composition 206 may be ex-situ sulfurized prior to being shipped to a refinery.

FIG. 3 is a process flow diagram of an embodiment of a method 300 for the ex-situ sulfurization of the ex-situ conditioned catalyst composition 206, in accordance with examples. In ex-situ sulfurization, the ex-situ conditioned catalyst composition 206 is treated to incorporate sulfur in the catalyst pores giving a sulfurized catalyst. In some examples, the sulfur-incorporated catalyst is contacted with organic compounds during or after the treatment to further increase the activity of the catalyst composition.

At block 302, the ex-situ conditioned catalyst composition 206 is contacted with elemental sulfur, or other sulfiding agent, under conditions which cause the sulfur to be incorporated into the pores of the catalyst by sublimation, melting, impregnation, or a combination thereof. The catalyst sulfiding agent may include any number of sulfur sources, such as elemental sulfur, or any one of a variety of sulfur compounds, such as hydrogen sulfide (H₂S), dimethyl sulfoxide (DMS), dimethyl disulfide (DMDS), di-tertiary model polysulfides (TNPS), mercaptans, and commercial sulfiding agents, such as SulfrZol® 54, among others.

At block 304, the ex-situ conditioned catalyst composition 206 is mixed with the sulfur source, such as powdered elemental sulfur, and heated at a temperature greater than about 80° C. to perform an initial sulfur impregnation. This initial sulfur impregnation may be carried out at a temperature ranging from about 90° C. to about 130° C. or higher, such as up to about 350° C. The temperature range may be determined by, and specified based on, the melting and sublimation characteristics of sulfur, or the properties of the sulfur compound, under the specific conditions of the sulfur-impregnation. The temperature may be limited by economics and other considerations. Implementing higher temperatures may be costlier. In a particular example, the catalyst composition and sulfur are heated together at a temperature ranging from about 105° C. to about 125° C.

In various examples, the ex-situ conditioned catalyst composition 206 and powdered sulfur are placed in a mixer, such as a vibratory or rotary mixer, and heated to the desired temperature for a specified time, such as about 0.1 hour to about 10 hours or longer, to incorporate the sulfur into the pores of the catalyst composition. The amount of sulfur added may depend upon the amount of catalytic metal present in the catalyst composition to be converted to the sulfide. In various examples, the amount of sulfur used is determined based on the stoichiometric amount of sulfur that converts most or all of the metal on the catalyst composition to the sulfide form. In one example, a catalyst composition containing molybdenum would receive about two moles of sulfur to convert each mole of molybdenum to molybdenum disulfide, with similar determinations being made for other metals.

The amount of elemental sulfur used for incorporation into the catalyst composition may typically range from about 0.5 to about 1.5 times the stoichiometric amount, or from about 0.7 to about 1.2 times the stoichiometric amount, or about 0.8 to about 1.1 times the stoichiometric amount, and the like. For a pygas catalyst, a target may typically be less than the stoichiometric amount, to allow the metals to be partially reduced. For pygas catalyst, an exemplary range may be 0.05 times the stoichiometric amount to 1.0 stoichiometric amount, or about 0.5 to about 1.0 times the stoichiometric amount, and the like.

For hydrotreating/hydrocracking and pygas treating catalysts containing Group VIB and/or Group VIII metals, the amount of sulfur employed may typically be about 2% to about 15% by weight of the catalyst composition charged. In other examples, the amount of sulfur employed may be about 6% to about 12% by weight of the catalyst composition charged.

In some examples, the amount of sulfur added may be such that the catalyst pores are not completely filled. By leaving residual pore volume, further treatments with organic compounds, such as olefins or mixtures of olefins and triglycerides, can penetrate the pores and react therein. If treatment with the organic compounds is performed, the sulfur-related impregnated metal catalyst is contacted with any compounds at an elevated temperature and specified time, such that the contact of the organic compounds with the sulfur-impregnated metal catalyst provides ex-situ sulfurized catalyst that is more resistant to sulfur leaching. Typically, the contact temperature is greater than about 150° C., such as in exemplary ranges of about 150° C. to about 350° C., or about 200° C. to about 325° C., and so forth. Contact times may depend on temperature and the vapor pressure of the olefin. Higher temperatures and higher vapor pressures may generally accommodate shorter times. In general, the time of contact of the organic compounds with the catalyst at elevated temperature may range from about 0.1 hour to about 10 hours to facilitate the formation of a carbonaceous barrier. In various examples, the heating of the mixture is performed in a substantially inert environment, such as under nitrogen.

In some examples, the ex-situ conditioned catalyst composition 206 is contacted with the elemental sulfur (e.g., powdered), and the organic compounds simultaneously or substantially simultaneously. According to such examples, a mixture of powdered elemental sulfur and organic compounds, may be first produced. A ratio of olefin to sulfur by weight may range from about 1:1 to about 4:1, or other ranges. An exemplary ratio value of olefin to sulfur is about 2:1. The mixture may be heated to promote homogenous mixing of the components, particularly if the olefinic hydrocarbon of the organic compounds is not liquid at ambient conditions. Toluene or other light weight hydrocarbon solvents may be added in the organic compounds to decrease the viscosity of the mixture. Also, increased heat may achieve the same effect. The organic compounds, may be added, for example, to a preweighed amount of catalyst and mixed. The resultant mixture may be heated to the reaction temperature of above about 150° C., for reaction of the olefin, or the olefin and the triglyceride, with the sulfur on the catalyst. The temperature may range about 150° C. to about 350° C., or about 200° C. to about 325° C., or other temperature ranges. The contact times at temperature may be, for example, about 0.1 to about 10 hours. Such a contract time range may be the same or similar as in various examples that may first contact the catalyst and with the sulfur, and then contact the sulfur-incorporated catalyst with the organic compounds at about 0.1 to about 10 hours at the elevated temperature to facilitate the formation of a carbonaceous barrier. During the heating process the sulfur generally initially impregnates the pores of the catalyst composition, while the olefin, or olefin and triglyceride, react with the sulfur and catalyst to form a catalyst composition which is resistant to leaching of the sulfur during startup of a hydroprocessing reactor.

The completion of the heating at block 304 results in the ex-situ sulfurized catalyst composition 306, which may include the impregnated with sulfur, or with both sulfur and the olefin, as described herein. As described with respect to FIG. 1 the ex-situ sulfurized catalyst composition 306 may be provided to a refinery, or may be further treated in an ex-situ sulfiding process as described with respect to FIG. 4.

FIG. 4 is a process flow diagram of a method 400 for the ex-situ sulfiding of the ex-situ sulfurized catalyst composition 306, in accordance with examples. The method 400 begins at block 402. At block 402, the ex-situ sulfurized catalyst composition 306 is contacted with hydrogen at temperatures greater than about 200° C., or from about 200° C. to about 350° C. The time at which the ex-situ sulfurized catalyst composition 306 is held at the elevated temperature may range from about 0.5 hours to about 24 hours.

The ex-situ sulfiding does not have to use an ex-situ sulfurized catalyst composition 306, but may be performed on the ex-situ conditioned catalyst composition 206. In this procedure, after the ex-situ conditioned catalyst composition 206 is contacted with the sulfurization chemicals at block 302 of FIG. 3 to impregnate the pores of the ex-situ conditioned catalyst composition 206 with sulfur. Process flow may then proceed directly to block 402 of FIG. 4, without the extra heating step described with respect to block 304. At block 402, the heated treatment gas, for example, hydrogen or a hydrogen mixture, is flowed through the sulfur impregnated catalyst composition. This directly forms the ex-situ sulfided catalyst composition 404.

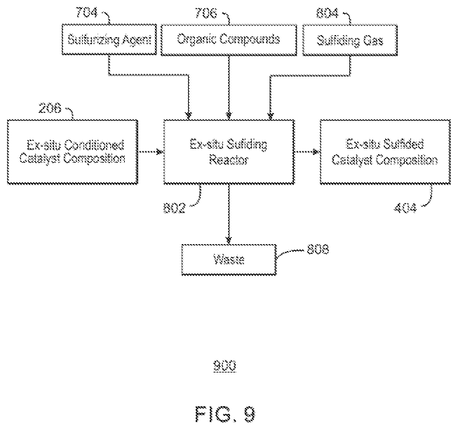

FIG. 5 is a process flow diagram of a method 500 for hydrotreating a hydrocarbon feed, in accordance with examples. The method begins at block 502, when the catalyst composition is loaded into a hydroprocessing reactor, such as a hydrotreating reactor, a hydrocracking reactor, or a pygas reactor, among others, and hydrogen flow is started to the reactor. The reactor is then heated to operating conditions for the process involved, such as hydrotreating, hydrocracking, or pygas treating. As described further with respect to FIG. 9, the reactor may be a fixed bed or a fluidized bed reactor.

At block 504, the catalyst composition is activated in the reactor. In various examples, the catalyst is sulfurized, sulfided, or activated in the hydroprocessing reactor, depending on which ex-situ treatments have taken place. If the catalyst is the ex-situ conditioned catalyst composition 206 described with respect to FIG. 2, a sulfur compound, as described herein, is added for sulfurizing the catalyst, prior to sulfiding the catalyst, as described herein.

If the catalyst is the ex-situ sulfurized catalyst composition 306 described with respect to FIG. 3, no further sulfur may be added, and the sulfurized catalyst is sulfided, e.g., during which the metal oxides and hydrogen react with most or substantially all of the sulfur incorporated into the catalyst pores, thus producing hydrogen sulfide, water, and metal sulfides. The sulfided catalyst may then be activated, as described herein.

If the catalyst is the ex-situ sulfided catalyst composition 404, described with respect to FIG. 4, the activation proceeds to the hydrotreating or hydrocracking process, in which a hydrogen flow, a hydrocarbon feedstock flow, or both, is started. In some examples, the hydrocarbon feedstocks flow is started after the hydrogen to ensure complete activation.

To begin the primary hydroprocessing, at block 506, the hydrocarbon feed and hydrogen is fed to the reactor across the sulfided catalyst composition in the reactor. At block 508, the hydrorocessing of the hydrocarbon feed, including catalyzing of the hydroprocessing, is performed by the sulfided catalyst composition. At block 510, a hydroprocessed hydrocarbon product exits the reactor. The hydrocarbon product may be subjected to additional processing, such as purification, removal of H₂S through absorption columns, distillation, and the like.

The continuous hydroprocessing, such as with continuous hydrotreating or pygas treating, may be run for a cycle of about two months up to six years or more. Once the catalyst productivity falls, indicating the activation, the catalyst may be replaced or rejuvenated for another cycle. In an example the hydroprocessing reactor is a continuous reactor. Refineries generally operate their hydroprocessing reactors in a continuous mode. The catalyst remains in the reactor and the hydrogen and hydrocarbon feed oil flow through the reactor, typically downflow, and the products are separated as they exit.

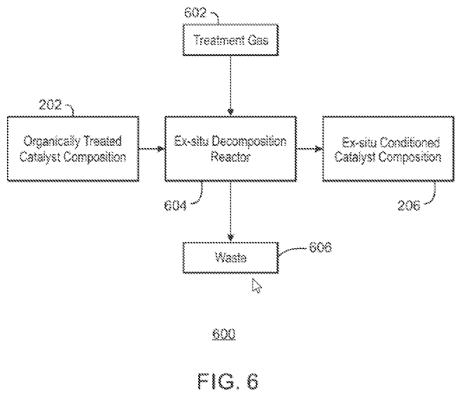

FIG. 6 is a simplified block diagram of a system 600 for ex-situ conditioning of an organically treated catalyst composition 202 with a heated treatment gas 602, in accordance with examples. Like numbered items are as described with respect to FIG. 2. The system 600 may be used to implement the method 400 described with respect to FIG. 4.

In the system 600, the organically treated catalyst composition 202 is fed to an ex-situ decomposition reactor 604. In some examples, the ex-situ decomposition reactor 604 is a batch reactor, such as a calcining reactor. In other examples, the ex-situ decomposition reactor 604 is a continuous feed reactor that may be included in the production process for the organically treated catalyst composition 202. The ex-situ decomposition reactor 604 may include paddles, or other devices, for stirring the organically treated catalyst composition 202 during the conditioning process. In some examples, the ex-situ decomposition reactor 604 is a fluidized bed reactor in which the treatment gas 602 fluidizes the organically treated catalyst composition 202 during the treatment process. In other examples, the ex-situ decomposition reactor 604 is a rotary drum reactor, in which the organically treated catalyst composition 202 is rotated while the treatment gas 602 is introduced.

As described herein, the treatment gas 602 may include nitrogen or a nitrogen and hydrogen mixture, for example. As the treatment gas 602 flows through the ex-situ decomposition reactor 604, the organically treated catalyst composition 202 decomposes, and the resulting waste compounds form a waste gas 606. The waste gas 606 may be treated by flowing through an absorption column, or may be sent to a flare header for incineration. The ex-situ conditioned catalyst composition 206 may then be removed from the ex-situ decomposition reactor 604 to be sent to a refinery, or may be further treated in an ex-situ sulfurization process, an ex-situ sulfiding process, or both.

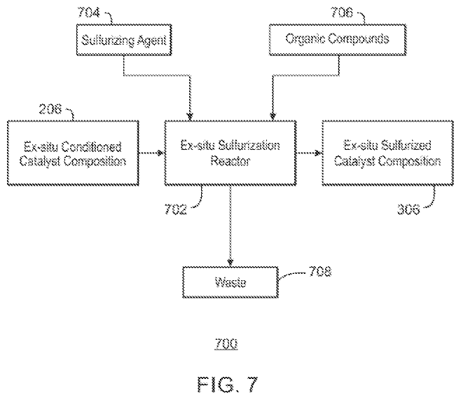

FIG. 7 is a simplified block diagram of a system 700 for the ex-situ sulfurization of an ex-situ conditioned catalyst composition 206, in accordance with examples. Like numbered items are as described with respect to FIGS. 2 and 3. The system 700 may be used to perform the methods described with respect to FIG. 3.

In the system 700, the ex-situ conditioned catalyst composition 206 is fed to an ex-situ sulfurization reactor 702. The ex-situ sulfurization reactor 702 may be the same vessel as the ex-situ decomposition reactor 604, with the ex-situ sulfurization performed sequentially after the ex-situ treatment.

The ex-situ sulfurization may be performed by loading a batch of the ex-situ conditioned catalyst composition 206 into the ex-situ sulfurization reactor 702 for treatment, or may be performed by a continuous feed of the ex-situ conditioned catalyst composition 206 through a continuous ex-situ sulfurization reactor 702.

A sulfurizing agent 704 is introduced into the ex-situ sulfurization reactor 702. As described herein, the sulfurizing agent 704 may include elemental sulfur, for example, blended into a suspension with a solvent, or other types of sulfur compounds, including hydrogen sulfide (H₂S), dimethyl disulfide (DMDS), di-tertiary butyl polysulfide (TBPS), and the like. In some examples, organic compounds 706 may be blended into the ex-situ conditioned catalyst composition 206 in the ex-situ sulfurization reactor 702. This may be performed after the initial sulfurization is completed, or in tandem with the sulfurizing agent 704.

Any waste products from the sulfurization process may be removed as a waste gas 708, for example, as described with respect to the waste gas 606 of FIG. 6. The waste gas 708 may be treated in a filtration or absorption system, sent to a flare header, or both. The ex-situ sulfurized catalyst composition 306 may then be removed from the ex-situ sulfurization reactor 702 to be sent to a refinery, or may be further treated in an ex-situ sulfiding process.

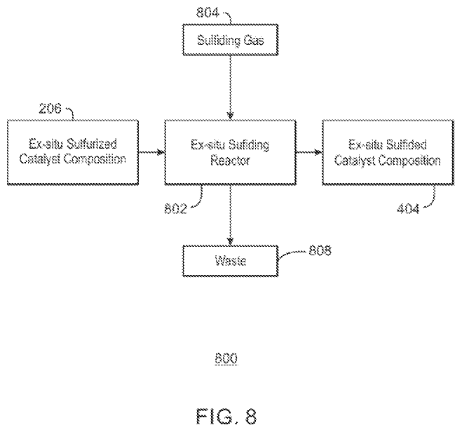

FIG. 8 is a simplified block diagram of a system 800 for ex-situ sulfiding of an ex-situ sulfurized catalyst composition 306, in accordance with examples. Like numbered items are as described with respect to FIGS. 3 and 4. The system 800 of FIG. 8 may be used to implement the method 400 of FIG. 4. The ex-situ sulfiding reactor 802 may be the same vessel as the ex-situ sulfurization reactor 702, with the ex-situ sulfiding performed sequentially after the ex-situ sulfurization treatment.

The ex-situ sulfiding may be performed by loading a batch of the ex-situ sulfurized catalyst composition 306 into the ex-situ sulfiding reactor 802 for treatment. A sulfiding gas 804, such as hydrogen or a hydrogen blend, is then flowed through the ex-situ sulfurized catalyst composition 306 as the ex-situ sulfurized catalyst composition 306 is heated. Any waste gases 808 may be treated as described with respect to the waste gas 708 of FIG. 7.

Once the ex-situ sulfiding treatment is completed, the ex-situ sulfided catalyst composition 404 can be optionally subjected to a passivation treatment step or may be immediately removed for packaging and shipped to a refinery. The ex-situ sulfided catalyst composition 404 is then loaded into a hydroprocessing reactor at the refinery.

FIG. 9 is a simplified block diagram of a system 900 for the direct ex-situ sulfiding of an ex-situ conditioned catalyst composition 206, in accordance with examples. Like numbered items are as described with respect to FIGS. 2, 4, 7, and 8. As described with respect to FIG. 4, the ex-situ conditioned catalyst composition 206 is fed to an ex-situ sulfiding reactor 802, then treated with a sulfurizing agent 704 and, in some examples, organic compounds 706, as described with respect to FIG. 7. The sulfur impregnated catalyst composition is then treated with a sulfiding gas 804, as described with respect to FIG. 8. The sulfur impregnated catalyst composition is heated, as described with respect to FIG. 4 to form the ex-situ sulfided catalyst composition 404. It can be noted that in the direct ex-situ sulfiding procedure, only one calcining step is performed, during the addition of the sulfiding gas 804.

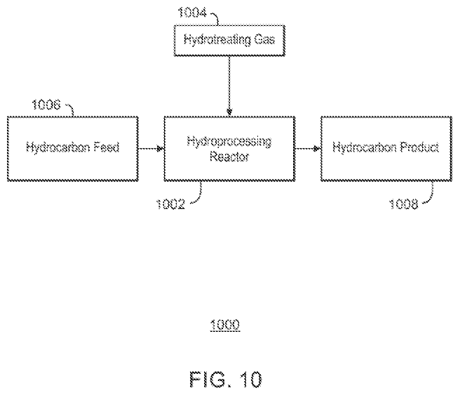

FIG. 10 is a simplified block diagram of a system 1000 for hydroprocessing of a hydrocarbon feed, in accordance with examples. The system 1000 of FIG. 10 may be used to implement the method 500 of FIG. 5. The catalyst composition is loaded into a hydroprocessing reactor 1002, a hydrotreating gas 1004 such as hydrogen, may be introduced to the hydroprocessing reactor 1002 to activate catalyst composition. In some examples, the hydrotreating gas 1004 is introduced along with a hydrocarbon feed 1006. In other examples, the hydrocarbon feed 1006 is introduced after the hydrotreating gas 1004 has been allowed to activate the catalyst composition. A continuous feed of the hydrocarbon product 1008 is removed from the hydroprocessing reactor 1002, and, as described herein, may be further processed into products.

### EXAMPLES

The techniques may be described by the following examples which are provided for illustrative purposes and are not to be construed as limiting the invention. Tables 2 and 3 below tabulates data for some particular examples.

Analysis Techniques

To test the performance of the ex-situ conditioned catalyst, the efficacy of sulfur removal through hydrotreating using a fresh catalyst was compared to the efficacy of each of a number of catalysts treated using different techniques. The efficacy was determined as a percentage ratio of the RVA HDS of the tested catalyst to a fresh catalyst. As used herein, RVA refers to relative volume activity and is used to measure a test catalyst sample against a known reference. As used herein, HDS refers to hydrodesulfurization, a process to remove sulfur products from a hydrocarbon feed.

In these examples, the RVA HDS was determined by measuring the sulfur product at the outlet of a pilot reactor over a period of days while running a hydrocarbon feed and a hydrogen gas stream through the reactor. The reactor temperatures, pressures, liquid hourly space velocity (LHSV), and sulfur product are then used to calculate an RVA number. The reference sample is 100% RVA and the test sample is a comparison to that sample. The tested feed included a straight run gas oil (SRGO) and a SRGO/light cycle oil (LCO) blend having the analysis results shown in Table 1.

TABLE 1
Feed Analysis

| | | | | SRGO/LCO |
|---|---|---|---|---|
| | | | | Blend |
| Method | Analysis | | SRGO | 70:30::SRGO:LCO |
| ASTM | API Gravity @ 60° F. (°API) | | 33.7 | 27.3 |
| D4052 | | | | |
| ASTM | Sulfur Content (wt. %) | | 0.501 | 1.05 |
| D4294 | | | | |
| ASTM | Flash Point (° F.) | | 163 | 176 |
| D93 | | | | |
| ASTM | Average Bromine Number | | 2.2 | 3.5 |
| D1159 | | | | |
| ASTM | Nitrogen (mg/kg) | | 200 | 270 |
| D4629 | | | | |
| ASTM | Temp @ 5% (° F.) | | 416.6 | 429.6 |
| D86 | | | | |
| | Temp @95% (° F.) | | 703.2 | 686.2 |
| IP | Aromatic | Mono | 19.8 | 17 |
| 391 | Hydro- | Di | 4.7 | 4.5 |
| | carbons | Tri+ | 0.1 | 0.3 |
| | (Vol %) | Polycyclic | 4.8 | 4.8 |
| | | Total | 24.6 | 21.8 |

Table 2 lists percentage carbon (% C) and loss on ignition (LOI) for each of the fresh and some of the post-treated catalysts in these experiments. For the carbon percentages, a carbon LECO test was used, which uses infrared absorption to measure carbon on the catalyst sample. The LOI determination involved heating the sample in a lab oven at 538° C. for one hour and measuring the weight of the sample before and after heating. Each of the fresh catalysts A-F were commercially-available catalysts that had been impregnated with non-aqueous compositions of organic materials at the end of their manufacture by the catalyst manufacturer. Catalysts A-E were based on nickel molybdenum (NiMo) catalysts. For example, the catalysts include about 16.7% Mo, about 3.6% Ni, and about 35.4% Al, e.g., which is part of an alumina support matrix. Catalyst F was a cobalt nickel (CoNi) catalyst.

TABLE 2
Analytical Data on Fresh and Pre-treated Catalyst

| Catalyst | % C | LOI % |
|---|---|---|
| Fresh Catalyst “A”. | 9.2-10.3 | 30.1-30.8 |
| Catalyst “A” air dried at 125-150 C. | 8.78 | 20.30 |
| Catalyst “A” air dried at 200-250 C. | 2.3 | 8.0 |
| Catalyst “A” N2 decomposed at 125-150 C. | 8.1-8.6 | 20.9-24.1 |
| Fresh Catalyst “B”. | 13.0 | 31.0 |
| Catalyst “B” N2 decomposed at 220 C. | 6.4 | 16.0 |
| Catalyst “B” N2 decomposed at 125-150 C. | 8.9-10.0 | 22.8-25.0 |
| Fresh Catalyst “C”. | 11.2 | 27.3 |
| Catalyst “C” N2 decomposed at 150 C. | 9.0 | 21.6 |
| Fresh Catalyst “D”. | 10.7-11.2 | 29.7-30.2 |
| Catalyst “D” N2 decomposed at 220 C. | 3.9-4.4 | 10.4-10.9 |
| Catalyst “D” N2 decomposed at 150-165 C. | 8.2-9.0 | 23.4-25.6 |
| Fresh Catalyst “E”. | 12.4-13.0 | 28.9-32.8 |
| Catalyst “E” N2 decomposed at 125-175 C. | 9.8-10.8 | 22.2-23.9 |
| Fresh Catalyst “F'. | 9.5-10.8 | 28.2-30.6 |
| Fresh catalyst “F” N2 decomposed at 125-150 C. | 7.2-8.4 | 20.6-22.5 |

Table 3 below compares the RVAs determined for each of the catalysts A-F in their freshly obtained state and after they were subjected to various ex situ conditioning treatments and, in some cases, ex situ pre-sulfiding. In Table 3, the first column lists the Sample number (Samp.). The second column lists the catalyst (e.g., Catalyst “A,” Catalyst “B,” etc.) and lists any ex situ conditioning performed for the respective sample. In examples that included air pre-treatment, the air pre-treatment was performed in a laboratory oven. In examples where the ex situ treatment comprised decomposition under N2 (or N2/H2), the ex situ treatment was performed using a pilot scale rotary calciner. Column 3 of Table 3 lists any pre-sulfiding treatment that was performed for each of the samples. Column 3 also lists which HDS protocol was used to determine the RVA for the sample. Protocol 1 included a 16-hour sulfiding period with a sulfur spiked feedstock, during which the reactor was brought from ambient temperature to above 300° C. before testing conditions were commenced. Protocol 2 was a longer, more drawn out startup process than Protocol 1. Protocol 2 had a 31-hour duration for in-situ sulfiding prior to commencing testing conditions. Protocol 2 was based on how a catalyst supplier of an organic-impregnated catalyst would typically instruct a commercial refiner to start their process so as to reduce exotherms and the potential for the organics & CO2 to be evolved downstream, causing issues for the refiner. In sum, Protocol 1 included a short in situ sulfiding process and Protocol 2 included a long in situ sulfiding process. Protocol 3 included no in situ sulfiding process and was used for samples of catalysts that had been subjected to ex situ sulfiding. Protocol 3 used only a 10 hour start up before testing conditions were commenced. During the testing phase, the hydroprocessing reactor was started up and ran for 3 days with the SRGO as the hydrocarbon feedstock. The reactor was then switched to 70/30 weight percent blend of SRGO/LCO as the hydrocarbon feedstock. The sulfur product was then measured throughout the SRGO and LCO feed runs and the RVA was measured as described above, with respect to a fresh catalyst sample. Notice that Samples 1, 15, 19, 21, 25, and 29 correspond to the fresh catalysts A-F, respectively. Those fresh catalysts examples were each taken as 100% RVA and the other samples of the same catalysts were measured relative to them. For example, Sample 1 (fresh Catalyst A) was considered as 100% RVA and the RVAs of samples 2-14 are relative to sample 1; Sample 15 (fresh Catalyst B) was considered 100% RVA and the RVA of samples 16-18 are relative to sample 15, and so on.

TABLE 3
Comparison of Activity Results- Examples and Counterexamples.

| | | | RVA (HDS) |
|---|---|---|---|
| | | In-Situ or Ex-Situ Sulfiding | vs. Fresh |
| | Catalyst and Ex Situ | Treatment and Activity Test | reference |
| Samp. | Conditioning | Protocol | catalyst |
| 1 | Fresh Catalyst “A”. | In-situ sulfiding using Protocol 1. | 100% |
| 2 | Fresh Catalyst “A”. | In-situ sulfiding using Protocol 2. | 101% |
| 3 | Fresh Catalyst “A” with 150 C. | Sulfur/Soy bean oil addition | 70% |
| | air pre-treatment. | calcined at 315 C. with no H2 for 15 | |
| | | mins. Activity tested using | |
| | | Protocol 3. | |
| 4 | Fresh Catalyst “A” with 150 C. | Sulfur addition calcined at 315 C. | 70% |
| | air pre-treatment. | with H2 for 15 mins. Activity | |
| | | tested using Protocol 3. | |
| 5 | Fresh Catalyst “A” with 150 C. | Sulfur addition. Calcined at 315 C. | 68% |
| | air pre-treatment. | with no H2 for 15 mins. Activity | |
| | | tested using Protocol 3. | |
| 6 | Fresh Catalyst “A” with 150 C. | Sulfrzol 54 addition calcined with | 79% |
| | air pre-treatment. | H2 addition at 220 C. for 30 mins, at | |
| | | 315 C. for 10 mins. Activity tested | |
| | | using Protocol 3. | |
| 7 | Fresh Catalyst “A” with 150 C. | Sulfur/Soybean oil addition | 68% |
| | air pre-treatment. | calcined (no H2) at 220 C. for 30 | |
| | | min, at 315 C. for 30 mins. Activity | |
| | | tested using Protocol 3. | |
| 8 | Fresh Catalyst “A” with 150 C. | Sulfur addition with catalyst and | 61% |
| | air pre-treatment. | heated in calciner at 120-130 C. for | |
| | | ~30 min hold then slow ramp to | |
| | | 175 C., hold for 30 mins then to 230 | |
| | | C. hold for 1 hour then to 300 C. for | |
| | | 30 mins with no H2 addition. | |
| | | Activity tested using Protocol 3. | |
| 9 | Fresh catalyst “A” was air dried | Added S and 50/50 blend of | 87% |
| | at 200 C. for 1 hour & 250 C. for | olefin/Soybean oil and calcined at | |
| | 1 hour. | 260 C. for 1 hour. Activity tested | |
| | | using Protocol 3. | |
| 10 | Fresh Catalyst “A” was | S and SBO addition to catalyst and | 112% |
| | decomposed at 120 C. for 1 | heated in calciner at 220 C. for 30 | |
| | hour hold under N2 & H2; H2 | mins then 315 C. for 30 mins with | |
| | added at 95 C. | no H2 addition. Activity tested | |
| | | using Protocol 3. | |
| 11 | Fresh Catalyst “A” | SBO and S addition to catalyst and | 100% |
| | decomposed under N2 only | heated in calciner at 220 C. for 30 | |
| | with 2 hour hold at 120 C. | mins then 315 C. for 30 mins with | |
| | | no H2 addition. Activity tested | |
| | | using Protocol 3. | |
| 12 | Fresh Catalyst “A” | Sulfur and SBO addition to catalyst | 107% |
| | decomposed under N2 only | and heated in calciner at 220 C. for | |
| | with 1 hour hold at 120 C. | 30 mins then 315 C. for 30 mins | |
| | | with no H2 addition. Activity | |
| | | tested using Protocol 3. | |
| 13 | Fresh Catalyst “A” | Added sulfur and 50/50 blend of | 110% |
| | decomposed under N2 only | olefin/Soybean oil and calcined at | |
| | with 1 hour hold at 125 C. | 260 C. for 1 hour. Activity tested | |
| | | using Protocol 3. | |
| 14 | Fresh catalyst “A” was N2 | In-situ sulfiding using Porocel | 110% |
| | decomposed at 135 C. for 1 | “short startup” protocol against test | |
| | hour hold. | protocol provided by fresh catalyst | |
| | | manufacturer- this test shows the | |
| | | decomposed material can be | |
| | | provided directly to refiner for | |
| | | faster in-situ sulfiding startup. | |
| | | Activity tested using Protocol 1. | |
| 15 | Fresh Catalyst “B”. | In-situ sulfiding using Protocol 2. | 100% |
| 16 | Fresh catalyst “B” was N2 | Added S and 50/50 blend of | 62% |
| | decomposed at 220 C. for 1-hour | olefin/SBO and calcined at 260 C. | |
| | hold. | for 1 hour. Activity tested using | |
| | | Protocol 3. | |
| 17 | Fresh Catalyst “B” was N2 | Added S and 50/50 blend of | 117% |
| | decomposed at 120 C. for 2 | olefin/SBO to catalyst and calcined | |
| | hours at temp, (max temp ~145 | at 225 C. for 1 hour. Activity tested | |
| | C). | using Protocol 3. | |
| 18 | Fresh catalyst “B” was N2 | S addition with 50/50 blend of | 99% |
| | decomposed at 125-150 C. for 1 | olefin/SBO and calcined at 220-240 | |
| | hour hold. | C. for 1 hour. Activity tested using | |
| | | Protocol 3. | |
| 19 | Fresh Catalyst “C”. | In-situ sulfiding using Protocol 2. | 100% |
| 20 | Fresh catalyst “C” was N2 | Added S and 50/50 blend of | 108% |
| | decomposed at 125-150 C. for 2 | olefin/SBO and calcined at 260 C. | |
| | hours. | for 1 hour. Activity tested using | |
| | | Protocol 3. | |
| 21 | Fresh Catalyst “D”. | In-situ sulfiding using Protocol 2. | 100% |
| 22 | Fresh Catalyst “D” was N2 | In-situ sulfiding using Protocol 2. | 133% |
| | decomposed at 150-165 C. at | | |
| | commercial scale for 45 | | |
| | minutes-1 hour residence time. | | |
| 23 | Fresh Catalyst “D” was N2 | Added S and olefin and calcined at | 105% |
| | decomposed at 150-165 C. at | 260 C. for 1 hour. Activity tested | |
| | commercial scale for 45 | using Protocol 3. | |
| | minutes-1 hour residence time. | | |
| 24 | Fresh Catalyst “D” was N2 | Added S and 50/50 blend of | 100% |
| | decomposed at 150-165 C. at | olefin/soybean oil and calcined at | |
| | commercial scale for 45 | 260 C. for 1 hour. Activity tested | |
| | minutes-1 hour residence time. | using Protocol 3. | |
| 25 | Fresh Catalyst “E”. | In-situ sulfiding using Protocol 2. | 100% |
| 26 | Fresh Catalyst “E” was N2 | Added S and 50/50 blend of | 109% |
| | decomposed at 125-175 C. at | olefin/soybean oil and calcined at | |
| | commercial scale for 45 | 260 C. for 1 hour. Activity tested | |
| | minutes-1 hour residence time. | using Protocol 3. | |
| 27 | Fresh Catalyst “E” was N2 | In-situ sulfiding using Protocol 1. | 99% |
| | decomposed at 125-175 C. at | | |
| | commercial scale for 45 | | |
| | minutes-1 hour residence time. | | |
| 28 | Fresh Catalyst “E” was N2 | In-situ sulfiding using Protocol 2. | 129% |
| | decomposed at 125-175 C. at | | |
| | commercial scale for 45 | | |
| | minutes-1 hour residence time. | | |
| 29 | Fresh Catalyst “F”. | In-situ sulfiding using Protocol 2. | 100% |
| 30 | Fresh catalyst “F” was N2 | Added S and 50/50 blend of | 98% |
| | decomposed at 125-150 C. for 1 | olefin/soybean oil and calcined at | |
| | hour. | 260 C. for 1 hour. Activity tested | |
| | | using Protocol 3. | |
| 31 | Fresh catalyst “F” was N2 | Added S and 50/50 blend of | 124% |
| | decomposed at 125-150 C. for 1 | olefin/soybean oil and calcined at | |
| | hour. | 300-315 C. for 1 hour with N2 & | |
| | | H2 atmosphere. Activity tested | |
| | | using Protocol 3. | |

To summarize the test results above, an organically treated catalyst composition that has been air treated at between about 200° C. and about 250° C. resulted in a poor RVA, while an organically treated catalyst composition conditioned under nitrogen at between about 125° C. and about 160° C. resulted in a good RVA. Further an organically treated catalyst composition that has been nitrogen treated at about 220° C. resulted in a poor RVA. Similarly, an organically treated catalyst composition treated under air at between about 125° C. and about 160° C. resulted in a poor RVA. Higher temperatures did not help air treatment, as an organically treated catalyst composition treated under air at between about 200° C. and about 250° C. resulted in a poor RVA. Further, an organically treated catalyst composition conditioned under nitrogen at between about 125° C. and about 150° C., and then sulfided in-situ provided better activity better activity on the equivalent start-up protocol and allowed for the use of a shorter start-up protocol compared to an organically treated catalyst composition that had not been conditioned under nitrogen prior to testing in a hydroprocessing reactor. In some instances (e.g., Catalyst E, Samples 25, 27, and 28), ex-situ conditioning provided significantly higher activity when the longer Protocol 2 start-up process was used (Sample 28), compared to the shorter Protocol 1 process (Sample 27). But, notice that the activity of the ex-situ conditioned catalyst using the short Protocol 1 start-up process (Sample 27) was commensurate with the activity of the fresh catalyst using the longer Protocol 2 start-up (Sample 25). In other words, the ex situ conditioning allowed the conditioned catalyst to perform as well using the shortened start-up as the fresh catalyst using the longer start-up. This results in benefits, such as less start-up time while still addressing CO2 evolution and downstream issues.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1-20. (canceled)

21. A method of conditioning an organically treated catalyst composition in preparation for a sulfiding treatment, the method comprising heating the organically treated catalyst composition in a treatment gas to form an ex-situ conditioned catalyst composition, wherein:
a) the organically treated catalyst composition comprises:
i) at least one metal supported on a porous support, and
ii) at least one organic reagent absorbed in pores of the porous support;
b) the heating decomposes at least a portion of the organic reagent leaving carbonaceous species in pores of the porous support.

22. The method of claim 21, wherein the organically treated catalyst composition has a carbon percent that is greater than 8% prior to heating.

23. The method of claim 21, wherein the organically treated catalyst composition comprises chromium, molybdenum, or tungsten, or any combinations thereof.

24. The method of claim 21, wherein the organically treated catalyst composition comprises nickel or cobalt.

25. The method of claim 21, wherein the organic reagent comprises one or more of an organic acid, an acetoacetic acid compound, a polar heterocyclic compound, a polyacidic compound, a nitrogen-containing organic compound, or a carbonate.

26. The method of claim 21, wherein the treatment gas comprises less than 10% oxygen.

27. The method of claim 21, wherein the treatment gas is nitrogen.

28. The method of claim 21, wherein the treatment gas is a mixture of nitrogen and hydrogen.

29. The method of claim 21, wherein the heating comprises flowing the treatment gas over the organically treated catalyst composition for up to 24 hours at a temperature of 230° C. or less.

30. The method of claim 21, wherein the heating comprises flowing the treatment gas over the organically treated catalyst composition for one hour or less at a temperature of 125° C. or greater.

31. The method of claim 21, wherein the heating comprises flowing the treatment gas over the organically treated catalyst composition at a temperature of 125° C. to 160° C. for 1 to 2 hours.

32. The method of claim 21, further comprising performing an ex-situ sulfurization of the ex-situ conditioned catalyst composition to form an ex-situ sulfurized catalyst composition.

33. The method of claim 22, wherein performing the ex-situ sulfurization comprises:
a) contacting the ex-situ conditioned catalyst composition with a sulfur source to form a mixture; and
b) heating the mixture to form the ex-situ sulfurized catalyst composition.

34. The method of claim 22, wherein performing the ex-situ sulfurization comprises:
a) contacting the ex-situ conditioned catalyst composition with sulfur; and one or more organic compounds to form a mixture; and
b) heating the mixture to form the ex-situ sulfurized catalyst composition.

35. The method of claim 24, wherein the one or more organic compounds comprise one or more of an olefin and a triglyceride.

36. The method of claim 22, further comprising performing an ex-situ sulfiding of the ex-situ sulfurized catalyst composition.

37. The method of claim 36, wherein the ex-situ sulfiding of the ex-situ sulfurized catalyst composition comprises heating the ex-situ sulfurized catalyst composition under a hydrogen-containing atmosphere.

38. The method of claim 21, further comprising performing an ex-situ sulfiding of the ex-situ conditioned catalyst composition to form an ex-situ sulfided catalyst composition.

39. The method of claim 38, wherein performing the ex-situ sulfiding comprises:
a) contacting the ex-situ conditioned catalyst composition with a sulfur source to form a mixture; and
b) heating the mixture under a flow of hydrogen to form the ex-situ sulfided catalyst composition.

40. A catalyst composition formed by the method claim 21.
